(19) United States
(12) Patent Application Publication
(10) Pub. No.: US 2013/0115347 A1
(43) Pub. Date: May 9, 2013

(54) Poultry Cooking Device and Method

(71) Applicant: Maple Leaf Foods Inc., Toronto (CA)

(72) Inventor: Neil Gregory Burns, Waterloo (CA)

(73) Assignee: MAPLE LEAF FOODS INC., Toronto (CA)

(21) Appl. No.: 13/671,247

(22) Filed: Nov. 7, 2012

Related U.S. Application Data
(60) Provisional application No. 61/556,377, filed on Nov. 7, 2011.

(51) Int. Cl. A47J 37/04; A23L 1/315

(52) U.S. Cl. CPC A47J 37/049; A23L 1/3155
USPC 426/281; 99/421 H; 426/523

(57) ABSTRACT

A poultry cooking device for removable insertion into an eviscerated abdominal cavity of a whole bird carcass prior to pre-cooking, and sized to fit within the cavity, is disclosed. The device includes an elongated member having first and second ends, the first end terminating in a taper. An at least one flange portion, for supporting the cavity during pre-cooking, is positioned between the first and second ends of the elongated member and extends outwardly therefrom, the presence of each flange portion creating an air channel for supporting uniform cooking of the carcass. A method of pre-cooking and rotisserie re-heating a whole bird carcass using the device of the present invention is also described.

The present application claims priority to application Ser. No. U.S. 61/556,377 filed on Nov. 7, 2011.

### FIELD

The present disclosure relates generally to cooking devices, and in particular to cooking devices used in the preparation of bird carcasses for consumption.

### BACKGROUND

Rotisserie cooking represents a popular method of roasting meat where the meat is cooked on a spit (or skewer) which is rotated slowly over a heat source. The rotation of the spit ensures even cooking on all sides of the meat. Poultry, and other birds, are typically cooked on a horizontal rotisserie, where the juices distribute evenly over the meat as the meat rotates on the spit, representing a further benefit of the rotisserie method. The rotisserie cooking method is generally used for cooking entire animals, such as whole chickens, whole turkeys, and the like. Owing to the popularity of rotisserie cooked meats within the general population (and in particular, owing to the popularity of rotisserie cooked chicken) rotisserie cooking methods are widely used in commercial enterprises, including popular restaurant chains.

With specific regard to the rotisserie chicken industry, chickens are often frozen whole, and must be thawed before being placed on a spit. Thawing enables the chicken to become flexible enough to conform to the shape of the skewer. Even when the birds are thawed, it can still be difficult to insert the skewer as the freezing process may alter the shape of the bird's abdominal cavity. In other cases, the cavity may have collapsed after evisceration and prior to the thawing process (whether through transportation of whole bird carcasses, upon freezing, or otherwise) which in turn can make skewer insertion difficult.

In any case, upon insertion of the skewer and placement of the bird in a rotisserie oven, the cooking process can take upwards of ninety minutes or longer to complete. As a result of this significant time lag, restaurant operators are required to run their rotisseries on a continuous, high-volume basis in order to meet customer demand in a timely manner. Unfortunately, certain fast food outlets and/or satellite restaurant locations may lack the necessary cooking infrastructure (i.e. complete rotisserie ovens) or volume demand required for efficient rotisserie operation. While other methods are known for cooking whole chickens (and other birds) in a rapid manner, including by microwave and by re-heating pre-cooked birds, since none of these methods involve rotisserie cooking, government regulations preclude proprietors of these methods from labeling, or otherwise referring to, their products as “rotisserie chicken” and/or “rotisserie cooked”. Unfortunately, once a whole chicken is pre-cooked, it is not only very difficult to insert a spit on a pre-cooked bird, but doing so will compromise the structural integrity of the bird, for example, by causing the bird to split, the back to break away and/or complete cavity collapse.

Given the popularity of rotisserie cooked foods in the marketplace (and in particular, rotisserie chicken) rotisserie restaurant operators could benefit from the use of a novel and inventive device and process for easily and rapidly cooking chicken (and other birds) via combined pre-cooking and rotisserie re-heating while maintaining the structural integrity of the bird during cooking and re-heating, which do not depend on economies of scale or expensive machinery, and which provide the added benefits of improved food safety and extended shelf-life.

### SUMMARY

The present disclosure relates to a poultry cooking device and method for facilitating the combined pre-cooking and rotisserie re-heating of a whole bird carcass.

In one embodiment, there is provided a device for removable insertion into an eviscerated abdominal cavity of a whole bird carcass prior to pre-cooking, and sized to fit within the cavity. The device firstly comprises an elongated member having first and second ends. The first end terminates in a taper. At least one flange portion, for supporting the cavity during pre-cooking, is positioned between the first and second ends of the elongated member and extends outwardly therefrom.

A method is also described for pre-cooking and rotisserie re-heating a whole bird carcass using the removable poultry cooking device described herein, the method characterized generally by the steps of tying the whole bird carcass around its breast and back; inserting the device into the eviscerated abdominal cavity of the bird such that the at least one flange portion supports the upper breast and side-wall sections of the cavity; cooking the whole bird carcass to produce a fully-cooked whole bird; removing the device from the fully-cooked whole bird and inserting a spit through the eviscerated abdominal cavity of the bird; placing the spit onto a rotisserie; and rotisserie re-heating the fully-cooked whole bird.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a perspective view of a poultry cooking device in accordance with an embodiment of the present invention;

FIG. 2 shows a top plan view of the poultry cooking device shown in FIG. 1;

FIG. 3 shows a side cross-sectional view of the poultry cooking device shown in FIG. 1;

FIG. 4 shows an end view of the poultry cooking device shown in FIG. 1; and

FIG. 5 shows a perspective view of a poultry cooking device in accordance with an alternate embodiment of the present invention.

In the drawings, preferred embodiments of the invention are illustrated by way of example. It is to be expressly understood that the drawings are only for the purpose of illustration and as an aid to understanding, and are not intended as a definition of the limits of the invention.

### DETAILED DESCRIPTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

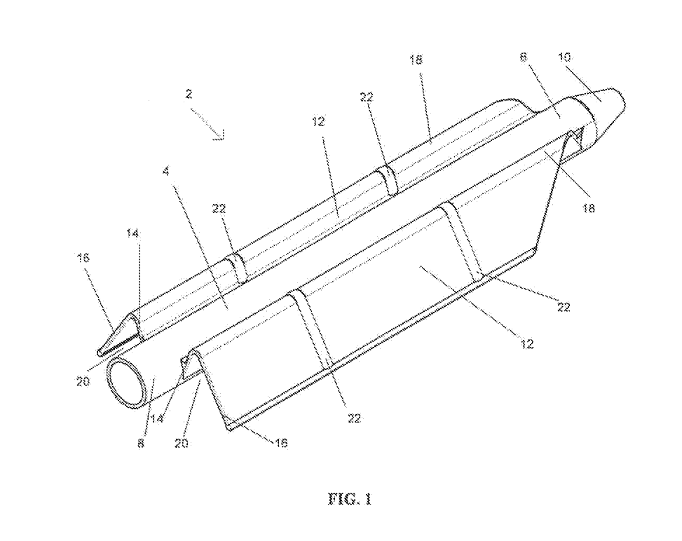

Referring to FIG. 1, a poultry cooking device is indicated generally by reference numeral 2. While it is expected that the device will be used primarily in the preparation of rotisserie chicken, a user of skill in the art will readily appreciate that the device, and functionality thereof, can be readily applied to the preparation of other whole bird carcasses, including, but not limited to, Cornish hens, turkeys and the like. The device 2 is designed for removable insertion into the eviscerated abdominal cavity of a whole uncooked bird carcass. The device principally comprises an elongated member 4 or shaft of longitudinal axis. The elongated member 4 may be substantially cylindrical in shape, however other shapes could be readily employed without departing from the scope of the invention. The elongated member 4 is characterized by a first end 6 and a second end 8, wherein the first end 6 is disposed proximate to the second end 8. In use, the device is to be inserted into the cavity of a bird using the first end 6 as the lead portion, such that the first end 6 is driven into the bird's cavity by applying force in the direction of the first end 6. In order to facilitate insertion of the device 2 into the cavity, the first end 6 may be designed to terminate in a taper 10. In one optional embodiment, the taper 10 can take the form of a single pointed tip of substantially conical shape. In another optional embodiment, the taper 10 can be substantially frusto-conically shaped, tapering inwardly toward the distal end of the taper 10. By tapering the first end 6, pushing force is focused on the first end 6, which makes insertion of the device 2 into the cavity easier. Further, optionally, the elongated member 4 could be tapered about the entirety of its longitudinal axis from a second end 8 of larger diameter to a first end 6 of smaller diameter.

In order to prevent the device 2 from becoming dislodged within the cavity of the bird, the second end 8 of the elongated member 4 may be fitted with a stopper (not shown) having a diameter greater than the outer diameter of the elongated member. The inclusion of such stopper prevents over-insertion of the device 2 into the bird's cavity and in turn, enables the device 2 to be easily removed from the cavity after use.

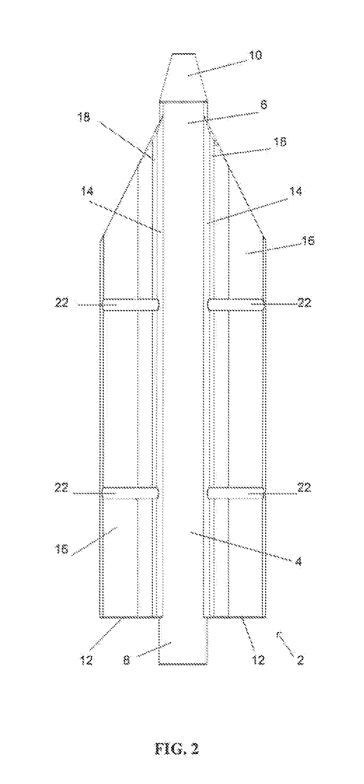

Referring to FIGS. 1 and 2, there is shown at reference numeral 12 flange portions positioned between the first end 6 and second end 8 of the elongated member 4. Each flange portion 12 extends outwardly from the outer surface of the elongated member 4. While any number of flange portions 12 could be used, in a preferred embodiment, there are two flange portions 12, each extending outwardly from opposite sides of the elongated member 4 for supporting at least the breast portions of the bird on either side of the elongated member 4. In one embodiment, the flange portions 12 are disposed on the elongated member 4 in diametric opposition to one another. The flange portions 12 serve to support the cavity of the bird against collapse during the cooking (also known as pre-cooking) stage as the upper sides of each flange portion 12 rest against and support the breast portions of the bird. In the absence of the flange portions 12, on cooking the breast portions would collapse around the elongated member 4.

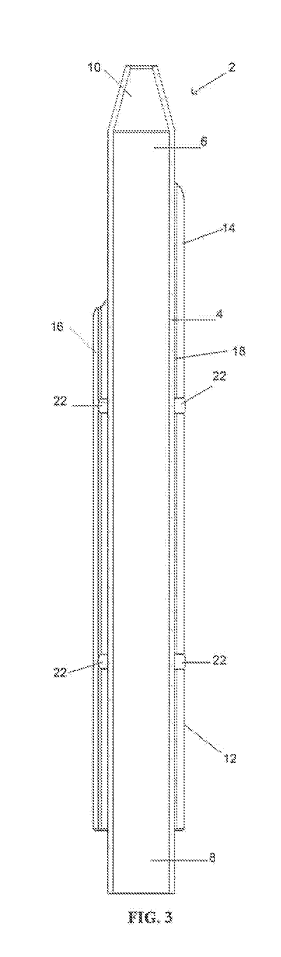

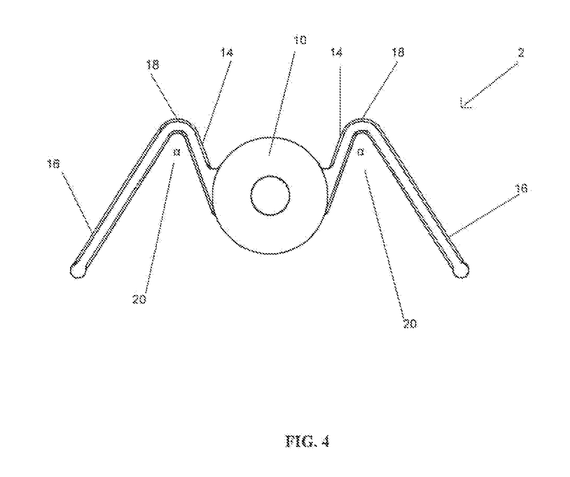

In one embodiment of the present invention, best shown in FIGS. 1 and 2, each flange portion 12 is composed of two horizontally opposed angled projections, being a first projection 14 and a second projection 16. Each projection 14, 16 has an upper surface and a lower surface. As illustrated in FIG. 1, the first projection 14 is inclined substantially upwardly from the elongated member, while the second projection 16, shown in FIGS. 1 and 3, emanates from the first projection 14 and is inclined substantially downwardly therefrom. By orienting the projections 14, 16 in this way, an upper ridge or platform 18 is established along the length of each flange portion 12, wherein each platform 18 serves to support the breast portions of the bird from collapse. Further, the outwardly extending upper surface of each second projection 16 serves to support the side-walls of the cavity from collapse. In this way, both the upper and side portions of the bird's cavity are supported during cooking. In addition, by orienting the first projection 14 and the second projection 16 in this manner, an air channel 20 is formed between the lower surfaces of the projections 14, 16 of each flange portion 12. Each air channel 20 functions to support uniform cooking of the bird by allowing air to circulate through the channels 20 within the interior-most portion of the bird's cavity. As a result, the interior of the bird will reach its target internal cooking temperature more quickly, thereby resulting in enhanced cooking efficiency. As best shown in FIG. 4, the lower surfaces of the first projection 14 and the second projection 16 are separated by angle α. Where a compact device design is preferred, angle α will be less than or equal to 90° (or acute), however, it will be readily appreciated that the angle α need not be strictly acute, since angles of α of 90° or greater can be employed without significantly materially affecting the function of the device.

Persons of skill in the art will also appreciate that different combinations of projections (and alternative orientations thereof) can be employed so long as the resulting flange structure includes an upper ridge or platform for supporting the breast portions of the bird, a substantially downwardly extending side panel or wall for supporting the side walls of the bird's cavity, and preferably, a channel formed between the projections for facilitating air flow during cooking.

The cross-sectional shape of the device 2 described above can be modeled to substantially conform to a cross-sectional shape of a standard commercial rotisserie spit. Modeling the device in this way will further help prevent cavity collapse and maintain the structural integrity of the bird during the preparation stages of removing the device from the bird's cavity after pre-cooking and skewering the pre-cooked bird onto a rotisserie spit for re-heating, wherein the spit is inserted through into the bird's cavity into the space formed by the device.

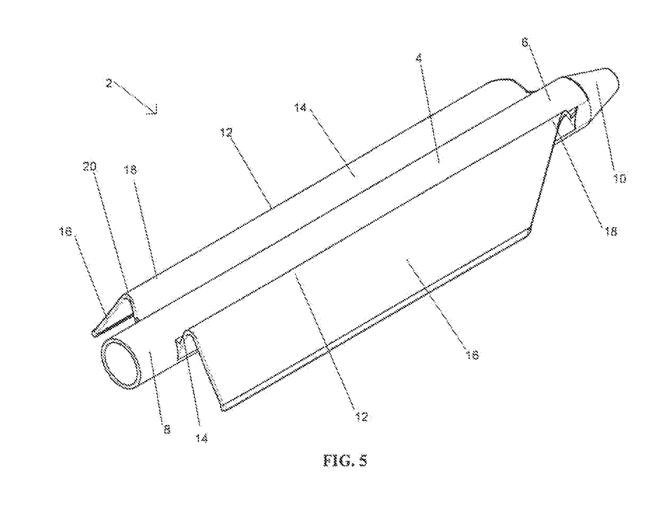

Referring again to FIGS. 1 and 2, there is shown an at least one supporting rib 22 disposed on each flange portion 12. Each of the at least one supporting ribs 22 extends along a latitudinal axis of each flange portion 12 for the purpose of enhancing the strength of each flange portion against flexure, or other bending or distortion of the flange portions 12. In the embodiment of the device illustrated in FIG. 5, no such supporting ribs are provided. The use of any supporting ribs, or an at least one supporting rib, as described above, is strictly optional.

The cooking device 2 is preferably composed of a food-safe, impermeable and non-leaching material (or combination of such materials) capable of withstanding temperatures in excess of 150° C. In a preferred embodiment, the device 2 is composed of a high temperature plastic. While the device 2 could be composed of metal, and optimally a non-ferrous metal, this may not be preferred as the metal character may interfere with food safety inspection protocols, which typically utilize a metal detection step.

In a method of pre-cooking and rotisserie re-heating a whole bird carcass, the removable poultry cooking device described herein is utilized. In such method, the whole bird carcass is tied around its breast and back portions, using, for example, standard cooking string. Tying the bird around its breast and back portions by separate ties serves to prevent back separation during the rotisserie re-heating step (discussed in detail below). Indeed, where the bird is not doubled tied in this manner, back fall-out is likely to occur on rotisserie re-heating. Next, the bird carcass may be injected, for example by needle injector, with a desired water-based solution (such as a brine solution of salt water and sodium phosophate plus flavor solution) for the purpose of enhancing the moisture content of the meat. This optional injection step, and any other pre-cooking preparatory steps, such as weighing/sizing, can be carried out at any time prior to pre-cooking. Next, the removable poultry cooking device previously described herein is inserted, via the first end thereof, into the eviscerated abdominal cavity of the whole bird carcass. As previously described, the presence of the optional stopper on the second end of the device prevents the device from becoming dislodged within the cavity and in turn enables a user to remove the device from the cavity with relative ease, simply by applying a backward force upon the stopper. Upon insertion, each flange portion functions to support the upper breast and side-wall sections of the bird's cavity and otherwise maintain the structural integrity of the cavity, while at the same time creating a channel (or channels) to facilitate air flow within the inner most portion of the cavity in order to accelerate the cooking process. Following device insertion, the whole bird carcass can be frozen and/or shipped for further processing prior to cooking. Further preparatory steps could be carried out following device insertion and prior to pre-cooking, such as bagging and vacuum-sealing the whole uncooked bird carcass with the device inserted. Cooking the bird within a bag or vacuum-sealed package aids to minimize or eliminate yield loss, resulting in a higher weight, moisture-rich end product.

At the pre-cooking (or cooking) stage, the whole bird carcass with device inserted is cooked using standard processes for a desired length of time and to a desired internal temperature, generally above 75° C. The fully cooked whole bird with device inserted may then be frozen prior to shipment to an end-user for eventual rotisserie re-heating. In order to re-heat the bird via rotisserie (such that the end-user can use “rotisserie” nomenclature when referring to the re-heated product) the end-user will remove the device from the fully cooked whole bird by applying a backward force while gripping the second end 8 of the device. Since the bird is pre-cooked with the device inserted in its abdominal cavity, upon removal of the device, a pre-formed for accommodating

Added benefits of pre-cooking the bird prior to shipment include extended shelf-life compared to that of an uncooked bird, and reduced or eliminated chicken weight loss of the rotisserie re-heated bird chicken compared to a rotisserie cooked fresh chicken.

While one or more embodiments of this invention have been illustrated in the accompanying drawings and described above, it will be evident to those skilled in the art that changes and modifications can be made therein without departing from the essence of this invention. All such modifications are believed to be within the sphere and scope of the invention as defined by the claims appended hereto.

What is claimed is:

1. A device for removable insertion into an eviscerated abdominal cavity of a whole bird carcass prior to pre-cooking, the device comprising:
an elongated member having a first end and a second end; and
an at least one flange portion positioned between the ends of the elongated member and extending outwardly therefrom, the at least one flange portion for supporting the cavity during pre-cooking,
wherein the device is sized to fit substantially within the cavity.

2. The device of claim 1, wherein the first end terminates in a taper.

3. The device of claim 1, wherein each of the at least one flange portions comprise two horizontally opposed angled projections, each projection having an upper and lower surface.

4. The device of claim 2 wherein a first projection of the two angled projections is inclined substantially upwardly from the elongated member and a second projection emanates from the first projection and is inclined substantially downwardly therefrom, the lower surfaces of the first projection and the second projection defining an air channel.

5. The device of claim 3 wherein the lower surfaces of the first projection and the second projection are separated by angle α.

6. The device of claim 4 wherein α≦90°.

7. The device of claim 1, wherein the at least one flange portion is two flange portions.

8. The device of claim 6, wherein the two flange portions are diametrically opposed to one another on the elongated member.

9. The device of claim 1, wherein a cross-sectional shape of the device substantially conforms to a cross-sectional shape of a standard commercial rotisserie spit.

10. The device of claim 1, wherein the second end of the elongated member is modified to include a stopper having a diameter greater than the outer diameter of the elongated member.

11. The device of claim 1, wherein the first end of the elongated member terminates in a single pointed tip.

12. The device of claim 2, wherein the taper is substantially frusto-conically shaped.

13. The device of claim 1 further comprising an at least one supporting rib disposed on each of the at least one flange portions, each of the at least one supporting ribs for enhancing the structural strength of each of the at least one flange portions.

14. The device of claim 1, wherein the elongated member is substantially cylindrical in shape.

15. A method of pre-cooking and rotisserie re-heating a whole bird carcass using a removable poultry cooking device for insertion into an eviscerated abdominal cavity of the bird prior to pre-cooking, the device comprising:
an elongated member having a first end and a second end; and
an at least one flange portion positioned between the ends of the elongated member and extending outwardly therefrom, the at least one flange portion for supporting the cavity during pre-cooking,
wherein the device is sized to fit substantially within the cavity, the method comprising the steps of:
I. tying the whole bird carcass around its breast and back;
II. inserting the device into the eviscerated abdominal cavity of the bird such that the at least one flange portion supports the upper breast and side-wall sections of the cavity;
III. cooking the whole bird carcass to produce a fully-cooked whole bird;
IV. removing the device from the fully-cooked whole bird and inserting a spit through the eviscerated abdominal cavity of the bird;
V. placing the spit onto a rotisserie; and
VI. rotisserie re-heating the fully-cooked whole bird.

16. The method of claim 10 further comprising the step of injecting the whole bird carcass with a brine solution after step I.

17. The method of claim 10 further comprising the step of bagging and vacuum sealing the whole bird carcass after step II.

18. The method of claim 10 further comprising the step of freezing the fully-cooked whole bird after step III.
